(19) United States
(12) Patent Application Publication
(10) Pub. No.: US 2018/0037199 A1
(43) Pub. Date: Feb. 8, 2018

(54) DEVICE FOR PREVENTING REARWARD MOVEMENT OF VEHICLE PEDAL ASSEMBLY

(71) Applicant: TOYODA IRON WORKS CO., LTD., Toyota-shi (JP)

(72) Inventor: Noboru FUJIWARA, Toyota-shi (JP)

(73) Assignee: TOYODA IRON WORKS CO., LTD., Toyota-shi (JP)

(21) Appl. No.: 15/714,565

(22) Filed: Sep. 25, 2017

Related U.S. Application Data
(63) Continuation-in-part of application No. PCT/JP2016/051331, filed on Jan. 18, 2016.

(30) Foreign Application Priority Data
Mar. 30, 2015 (JP) 2015-070386
Sep. 16, 2015 (JP) 2015-183477

(51) Int. Cl. B60T 7/06; G05G 1/323

(52) U.S. Cl. CPC B60T 7/065; G05G 1/323

(57) ABSTRACT

A vehicle pedal device rearward movement preventing device includes: a sub bracket coupled to a pedal bracket being rotatable about a second axis parallel to a first, and having one end extending beyond the pedal bracket toward a rear of the vehicle; and a support member mounted on a vehicle body-side member located closer to the driver's seat than the dash panel, supporting the one end of the sub bracket, and allowing the one end to be disengaged from the support member when the sub bracket is moved rearward with the rearward movement and displacement of the dash panel. When the one end is disengaged from the support member, the sub bracket is withdrawn and rotated about the second axis so that the one end is displaced toward a vehicle lower side, allowing the operation pedal pedal portion to be mechanically restrained from being moved rearward toward the driver's seat.

### TECHNICAL FIELD

The present invention relates to rearward movement preventing devices for vehicle pedal devices which restrain a pedal portion of an operation pedal from being moved rearward toward a driver's seat when a dash panel is moved rearward and displaced toward the driver's seat.

### BACKGROUND ART

Rearward movement preventing devices for vehicle pedal devices are known in the arts, in which the vehicle pedal device includes (a) a pedal bracket that is mounted on a dash panel, and (b) an operation pedal that is directly or indirectly supported by the pedal bracket such that the operation pedal can rotate about a first axis, that is mechanically coupled to a predetermined output member, and that includes at its lower end a pedal portion that is depressed toward the front of a vehicle, and (c) the rearward movement preventing device restrains the pedal portion of the operation pedal from being moved rearward toward a driver's seat when the dash panel is moved rearward and displaced toward the driver's seat. A device described in Patent Document 1 is one example of such a rearward movement preventing device. The device described in Patent Document 1 includes (d) a support member that is mounted on a vehicle body-side member located closer to the driver's seat than the dash panel, that supports a tip end (end closer to the rear of the vehicle) of the pedal bracket, and that allows the tip end to be disengaged from the support member when the pedal bracket is moved rearward with the rearward movement and displacement of the dash panel, and (e) a guide that is mounted on the vehicle body-side member, and that guides the tip end, having been disengaged from the support member, so that the tip end is displaced toward the lower side of the vehicle when the pedal bracket is moved rearward with the rearward movement and displacement of the dash panel. In the device described in Patent Document 1, (f) the pedal bracket is bent and deformed so that the tip end is displaced toward the lower side of the vehicle, which mechanically restrains rearward movement of the pedal portion of the operation pedal disposed in the pedal bracket.

Patent Document 2 describes a device that includes (d) a sub bracket that is coupled to the pedal bracket such that the sub bracket can rotate about a second axis parallel to the first axis, and that has its one end extended beyond the pedal bracket toward the rear of the vehicle, and (e) a guide that is mounted on the vehicle body-side member located closer to the driver's seat than the dash panel is, and that guides the one end of the sub bracket so that the one end of the sub bracket is displaced toward the lower side of the vehicle when the pedal bracket is moved rearward with the rearward movement and displacement of the dash panel. In the device described in Patent Document 2, (f) the sub bracket is withdrawn and rotated about the second axis so that the one end is displaced toward the lower side of the vehicle, which mechanically restrains rearward movement of the pedal portion of the operation pedal disposed in the sub bracket.

### RELATED ART DOCUMENTS

### Patent Documents

Patent Document 1: Japanese Patent Application Publication No. H10-59146

Patent Document 2: Japanese Patent Application Publication No. H11-139346

### SUMMARY OF THE INVENTION

### Problem to be Solved by the Invention

However, the rearward movement preventing device of Patent Document 1 restrains rearward movement of the pedal portion of the operation pedal based on bending and deformation of the pedal bracket. The rearward movement preventing device of Patent Document 1 is therefore disadvantageous in that rearward movement of the pedal portion tends not always to be restrained to the same extent as the pedal bracket is not always deformed in the same manner. It is difficult to always deform the pedal bracket in the same manner. In the rearward movement preventing device of Patent Document 2, the sub bracket is rotated about the second axis. The rearward movement preventing device of Patent Document 2 can therefore be expected to restrain rearward movement of the pedal portion to the same extent based on the rotation of the sub bracket. However, since the sub bracket is held in a fixed attitude on the pedal bracket by clinching or projections, holding strength of the sub bracket is affected by the strength and rigidity of the pedal bracket, and it is difficult to appropriately release the sub bracket when the dash panel is moved rearward and displaced in case of a collision etc. while ensuring holding strength high enough to appropriately support the operation pedal. That is, in the structure in which the pedal bracket and the sub bracket are fastened together as in Patent Document 2, it is necessary to achieve both of normal operation in which the operation pedal is depressed and the function to disengage the sub bracket in case of a collision. This restricts flexibility of design in view of the friction and axial force of a fastened portion, cutout shape, etc., and it is difficult to reliably disengage the sub bracket in case of a collision to restrain rearward movement of the pedal portion. Moreover, if the pedal bracket is deformed by a collision, the sub bracket may not be able to be disengaged due to twisting etc. in the portion where the pedal bracket and the sub bracket are fastened together.

The present invention was developed in view of the above circumstances and it is an object of the present invention to allow a sub bracket to be appropriately held in a predetermined attitude during normal operation and allow the sub bracket to be appropriately released in case of a collision etc. in a rearward movement preventing device for a vehicle pedal device in which the sub bracket is mounted on a pedal bracket such that the pedal bracket can rotate about a second axis.

### Solution to Problem

To achieve the above object, a first aspect of the present invention provides a rearward movement preventing device for a vehicle pedal device, the vehicle pedal device including (a) a pedal bracket that is mounted on a dash panel, and (b) an operation pedal that is directly or indirectly supported by the pedal bracket such that the operation pedal can rotate about a first axis, that is mechanically coupled to a predetermined output member, and that includes at its lower end a pedal portion that is depressed toward a front of a vehicle, and (c) the rearward movement preventing device restraining the pedal portion of the operation pedal from being moved rearward toward a driver's seat when the dash panel is moved rearward and displaced toward the driver's seat, the rearward movement preventing device comprising: (d) a sub bracket that is coupled to the pedal bracket such that the sub bracket can rotate about a second axis parallel to the first axis, and that has its one end extended beyond the pedal bracket toward a rear of the vehicle; and (e) a support member that is mounted on a vehicle body-side member located closer to the driver's seat than the dash panel, that supports the one end of the sub bracket, and that allows the one end to be disengaged from the support member when the sub bracket is moved rearward with the rearward movement and displacement of the dash panel, wherein (f) when the one end is disengaged from the support member, the sub bracket is withdrawn and rotated about the second axis so that the one end is displaced toward a lower side of the vehicle, which allows the pedal portion of the operation pedal to be mechanically restrained from being moved rearward toward the driver's seat based on the mechanical coupling between the output member and the operation pedal.

The vehicle body-side member located closer to the driver's seat than the dash panel is an instrument panel reinforcement (a reinforcement member for an instrument panel), a cowl bracket, etc. This vehicle body-side member is less likely to be displaced toward the driver's seat, namely toward the rear of the vehicle, than the dash panel and is deformed by an amount smaller than that of the dash panel, when subjected to a large load from the front of the vehicle in case of a collision etc. The present invention is a technique of restraining rearward movement of the pedal portion of the operation pedal on the assumption that there is the difference in amount of deformation between the vehicle body-side member and the dash panel. The withdrawal and rotation of the sub bracket includes the case where the one end of the sub bracket is displaced toward the lower side of the vehicle by natural dropping due to gravity or by an elastic body.

A second aspect of the present invention provides the rearward movement preventing device for the vehicle pedal device recited in the first aspect of the present invention, wherein a guide is mounted on the vehicle body-side member, and the guide guides the one end, having been disengaged from the support member, so that the one end is displaced toward the lower side of the vehicle when the sub bracket is moved rearward with the rearward movement and displacement of the dash panel.

A third aspect of the present invention provides the rearward movement preventing device for the vehicle pedal device recited in the first or second aspect of the present invention, wherein (a) the operation pedal is rotatably disposed in the sub bracket, (b) an intermediate lever, which is coupled to the output member and is coupled to the operation pedal via a coupling link, is disposed in the pedal bracket such that the intermediate lever can rotate about a third axis parallel to the first axis, and (c) with the withdrawal and rotation of the sub bracket, the operation pedal is pulled by the intermediate lever and the pedal portion is moved toward the front of the vehicle.

A fourth aspect of the present invention provides the rearward movement preventing device for the vehicle pedal device recited in the third aspect of the present invention, wherein the third axis coincides with the second axis, and the intermediate lever and the sub bracket are rotatably supported by a common support shaft.

A fifth aspect of the present invention provides the rearward movement preventing device for the vehicle pedal device recited in the first or second aspect of the present invention, wherein (a) the operation pedal is rotatably disposed in the pedal bracket, (b) an intermediate lever, which is coupled to the output member and is coupled to the operation pedal via a coupling link, is disposed in the sub bracket such that the intermediate lever can rotate about a third axis parallel to the first axis, and (c) with the withdrawal and rotation of the sub bracket, the operation pedal is pulled by the intermediate lever and the pedal portion is moved toward the front of the vehicle.

A sixth aspect of the present invention provides the rearward movement preventing device for the vehicle pedal device recited in the fifth aspect of the present invention, wherein the first axis coincides with the second axis, and the operation pedal and the sub bracket are rotatably supported by a common support shaft.

A seventh aspect of the present invention provides the rearward movement preventing device for the vehicle pedal device recited in the first or second aspect of the present invention, wherein (a) the operation pedal is disposed in the sub bracket at a position located on an upper side of the vehicle with respect to the second axis such that the operation pedal can rotate about the first axis, (b) the output member is coupled directly to the operation pedal at an intermediate position between the first axis and the pedal portion, and (c) with the withdrawal and rotation of the sub bracket, the operation pedal is pulled by the output member and the pedal portion is moved toward the front of the vehicle.

An eighth aspect of the present invention provides the rearward movement preventing device for the vehicle pedal device recited in the first or second aspect of the present invention, wherein (a) the operation pedal is rotatably disposed in the sub bracket, and (b) an intermediate lever, which is coupled to the output member and is coupled to the operation pedal via a coupling link, is disposed in the sub bracket such that the intermediate lever can rotate about a third axis parallel to the first axis, and (c) with the withdrawal and rotation of the sub bracket, the operation pedal is pulled by the intermediate lever and the pedal portion is moved toward the front of the vehicle.

A ninth aspect of the present invention provides the rearward movement preventing device for the vehicle pedal device recited in the eighth aspect of the present invention, wherein (a) the sub bracket has the other end extended toward the front of the vehicle, which is toward an opposite side of the second axis from the one end, and (b) the operation pedal and the intermediate lever are rotatably disposed in parts of the sub bracket which are located on opposite sides of the second axis in a longitudinal direction of the vehicle.

### BRIEF DESCRIPTION OF DRAWINGS

FIG. 1 is a partially cutaway left side view showing a schematic configuration of a brake pedal device to which the present invention is applied.

FIG. 2 is an enlarged sectional view taken along line II-II and viewed in the direction of arrows II in FIG. 1.

FIG. 3 is a perspective view showing only a slide member attached to a sub bracket of an embodiment in FIG. 1.

FIGS. 4A and 4B are views illustrating how rearward movement of a pedal portion of an operation pedal is restrained when a dash panel is moved rearward and deformed by a collision in the embodiment of FIG. 1.

FIGS. 5A and 5B are views corresponding to FIGS. 4A and 4B, showing another embodiment of the present invention.

FIGS. 6A and 6B are views corresponding to FIGS. 4A and 4B, showing still another embodiment of the present invention.

FIGS. 7A and 7B are views corresponding to FIGS. 4A and 4B, showing still another embodiment of the present invention.

FIGS. 8A and 8B are views corresponding to FIGS. 4A and 4B, showing still another embodiment of the present invention.

FIGS. 9A and 9B are views corresponding to FIGS. 4A and 4B, showing still another embodiment of the present invention

### MODES FOR CARRYING OUT THE INVENTION

The present invention is preferably applied to vehicle pedal devices whose output member is disposed so as to project through the dash panel into a passenger compartment, such as brake pedal devices for service brakes to which, e.g., an operating rod of a brake booster is coupled as an output member. The present invention is also applicable to other vehicle pedals such as an accelerator pedal, a clutch pedal, and a parking brake pedal.

The dash panel is a partition wall that separates the passenger compartment from an engine room. However, an engine need not necessarily be accommodated in the engine room, and the dash panel may be any component that forms a front wall of the passenger compartment. For example, the operation pedal is disposed in the pedal bracket or the sub bracket such that the operation pedal can rotate about the first axis that is substantially horizontal and substantially parallel to the lateral direction of the vehicle. For example, it is desirable that the operation pedal be coupled to the output member via the intermediate lever and the operation pedal and the intermediate lever be coupled via the coupling link. However, the operation pedal and the intermediate lever may be directly coupled via a long hole. The operation pedal and the output member may be coupled via a plurality of intermediate levers.

For example, the support member that supports the sub bracket so that the one end of the support member can be disengaged includes a coupling member such as a rivet which is broken when subjected to a predetermined disengagement load, or a fastening device such as a nut and a bolt that are fastened so as to be disengaged from a slit etc. by sliding when subjected to the predetermined disengagement load. For example, the support member allows the sub bracket to be disengaged from the support member when subjected to such a load that moves the one end of the sub bracket rearward substantially horizontally toward the rear of the vehicle, and appropriately keeps the sub bracket supported when subjected to a load in any other direction.

In the second aspect of the present invention, the one end of the sub bracket is forced to be displaced toward the lower side of the vehicle by the guide. However, when carrying out other aspects of the present invention, the one end of the sub bracket may be displaced toward the lower side of the vehicle by an elastic member such as a spring or may be merely displaced toward the lower side of the vehicle by its own weight. The guide has desirably a flat tilted surface tilted obliquely downward, but may have a curved surface. The guide displaces the one end of the sub bracket toward the lower side of the vehicle when the one end of the sub bracket is in contact with the guide. A guide pin etc. may be used as the guide.

In the fourth aspect of the present invention, the third axis coincides with the second axis, and in the sixth aspect of the present invention, the first axis coincides with the second axis, and the common support shaft is used in the fourth and sixth aspects of the present invention. However, when carrying out other aspects of the present invention, the intermediate lever or the operation pedal and the sub bracket may be supported by separate support shafts, and the first axis, the second axis, and the third axis may be located at different positions from each other. Although at least one of the operation pedal and the intermediate lever is rotatably disposed in the sub bracket, it is desirable that the first axis or the third axis, which is the rotation axis of the operation pedal or the intermediate lever, be located in a part that does not overlap the pedal bracket as viewed from the side. In this case, even if the pedal bracket is deformed by a vehicle collision, the support shaft etc. that is disposed along the first axis or the third axis is restrained from interfering with the pedal bracket, and the sub bracket is withdrawn and rotated appropriately.

In the eighth aspect of the present invention, both the operation pedal and the intermediate lever are rotatably disposed in the sub bracket. In the ninth aspect of the present invention, the operation pedal and the intermediate lever are disposed in the parts of the sub bracket which are located on the opposite sides of the second axis in the longitudinal direction of the vehicle. When carrying out the eighth aspect of the present invention, both the operation pedal and the intermediate lever may be disposed on the rear side or front side of the vehicle with respect to the second axis. In the ninth aspect of the present invention, the operation pedal may be rotatably disposed on the front side of the vehicle with respect to the second axis and the intermediate lever may be rotatably disposed on the rear side of the vehicle with respect to the second axis. Alternatively, the operation pedal may be rotatably disposed on the rear side of the vehicle with respect to the second axis and the intermediate lever may be rotatably disposed on the front side of the vehicle with respect to the second axis.

### EMBODIMENTS

Embodiments of the present invention will be described in detail with reference to the accompanying drawings. The figures in the following embodiments are shown simplified or deformed as appropriate for the purpose of illustration, and each part is not necessarily drawn at an accurate dimensional ratio, in an accurate shape, etc.

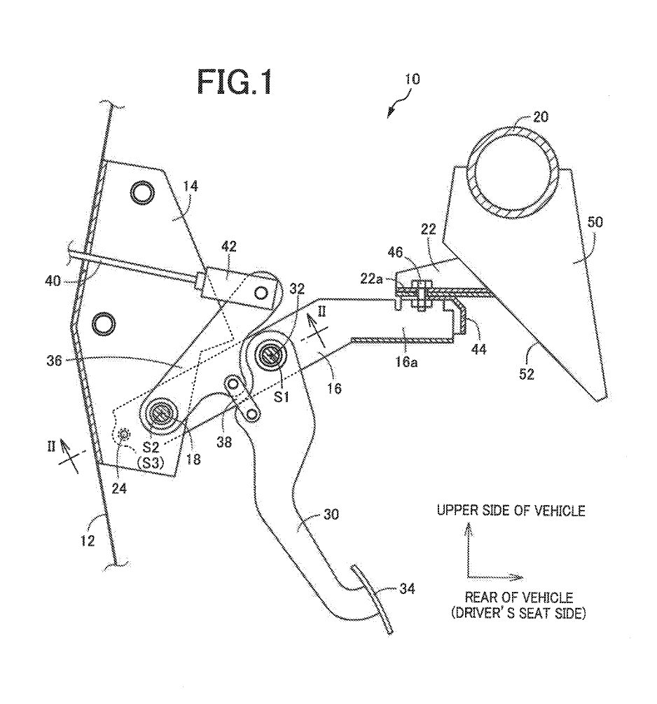

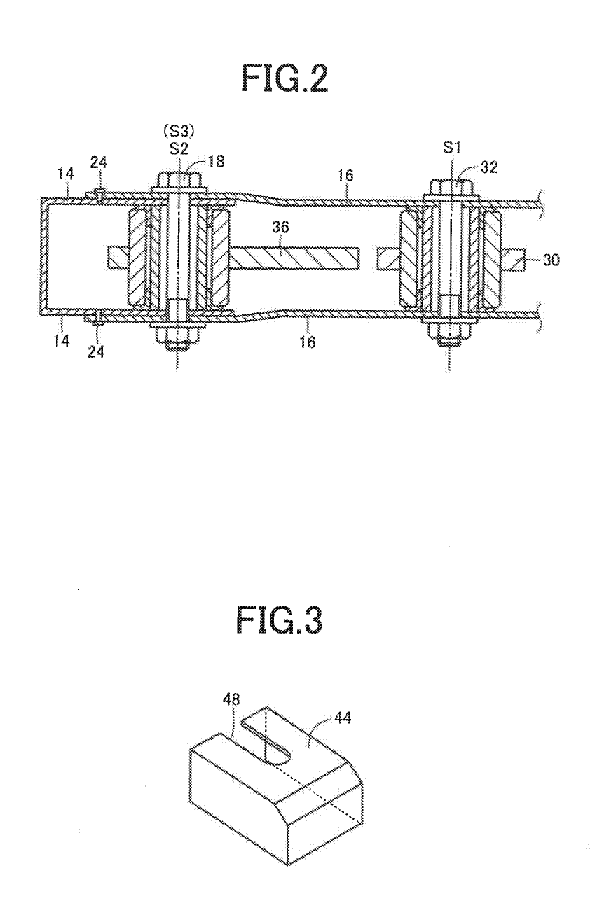

FIG. 1 is a partially cutaway left side view illustrating a brake pedal device 10 for service brake to which the present invention is applied, as viewed from the left side of a vehicle. FIG. 2 is an enlarged sectional view taken along line II-II and viewed in the direction of arrows II in FIG. 1. The brake pedal device 10 corresponds to the vehicle pedal device. A pedal bracket 14 is fixedly attached to a dash panel 12 that separates an engine room from a passenger compartment, and a sub bracket 16 is mounted on the pedal bracket 14 such that the sub bracket 16 can rotate about the axis of a second support shaft 18 that is substantially horizontal and substantially parallel to the lateral direction of the vehicle. The axis of the second support shaft 18 is a second axis S2 that is a rotation axis of the sub bracket 16. The sub bracket 16 has a longitudinal shape and is extended obliquely upward toward the rear of the vehicle beyond the pedal bracket 14. The sub bracket 16 is, at its one end 16a, coupled to and supported by a support member 22 fixed to an instrument panel reinforcement 20. The sub bracket 16 is normally held in a certain assembled attitude shown in FIG. 1. Each of the pedal bracket 14 and the sub bracket 16 includes a pair of side plates parallel to each other. In the present embodiment, the sub bracket 16 is mounted on the pedal bracket 14 so as to be in close contact with the outer surfaces of the pedal bracket 14. The pedal bracket 14 and the sub bracket 16 are positioned with a relatively weak temporary fixing pin 24 made of aluminum etc. so that the sub bracket 16 is held in the assembled attitude even before the sub bracket 16 is coupled at its one end 16a to the support member 22. The instrument panel reinforcement 20 corresponds to the vehicle body-side member located closer to the driver's seat than the dash panel 12 is. The instrument panel reinforcement 20 is thus less likely to be displaced toward the rear of the vehicle than the dash panel 12 and is deformed by an amount smaller than that of the dash panel 12, when subjected to a large load from the front of the vehicle in case of a vehicle collision etc.

An operation pedal 30 is disposed in a part of the sub bracket 16 which is located at an intermediate position of the sub bracket 16, namely at a position between the second axis S2 and the one end 16a, and which does not overlap the pedal bracket 14 as viewed in the side view of FIG. 1. The operation pedal 30 is disposed such that the operation pedal 30 can rotate about the axis of a first support shaft 32 substantially parallel to the second support shaft 18. The axis of the first support shaft 32 is a first axis S1 that is a rotation axis of the operation pedal 30. The operation pedal 30 is rotatably supported at its upper end by the first support shaft 32, so that a pedal portion 34 at the lower end of the operation pedal 30 can be depressed toward the front of the vehicle (to the left in FIG. 1). An intermediate lever 36 is disposed in the pedal bracket 14 such that the intermediate lever 36 can rotate about the second axis S2. The second axis S2 coincides with a third axis S3 that is a rotation axis of the intermediate lever 36, and the sub bracket 16 and the intermediate lever 36 are supported by the common second support shaft 18 such that the sub bracket 16 and the intermediate lever 36 can rotate relative to each other. The intermediate lever 36 is supported at its lower end such that the intermediate lever 36 can rotate about the second axis S2. The intermediate lever 36 extends upward and is coupled at its intermediate position in the vertical direction to the operation pedal 30 via a coupling link 38. An operating rod 40 of a brake booster is coupled to the upper end of the intermediate lever 36 via a clevis 42. When the operation pedal 30 is depressed, the intermediate lever 36 is mechanically rotated counterclockwise (output direction) about the second support shaft 18 via the coupling link 38 accordingly. The operating rod 40 is thus pressed toward the front of the vehicle to generate a braking force. The operating rod 40 corresponds to the output member and is disposed so as to project through the dash panel 12 into the passenger compartment.

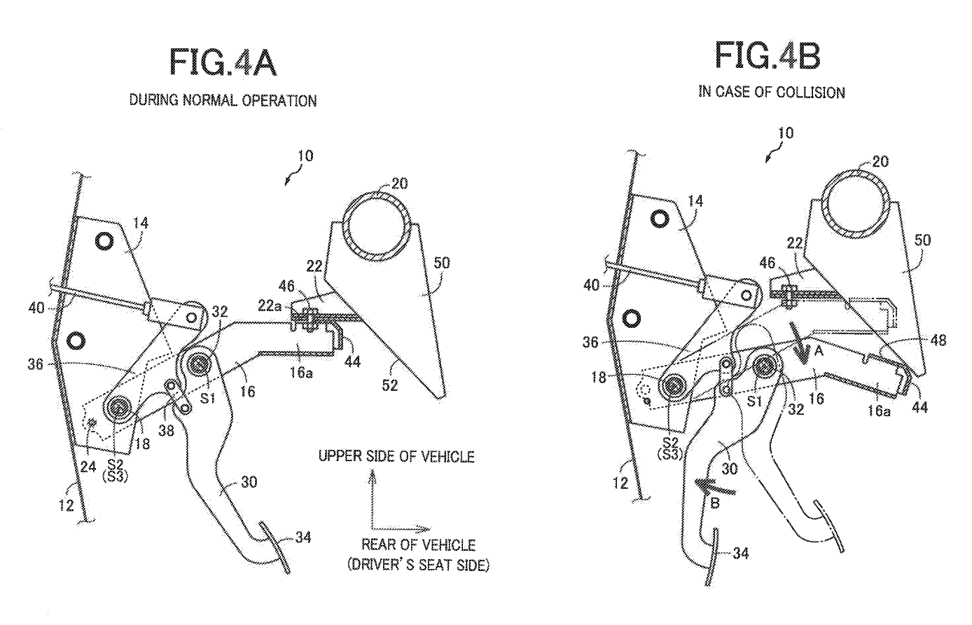

The support member 22 includes a substantially horizontal, flat support plate portion 22a. The sub bracket 16 is bent such that the one end 16a extends substantially horizontally, and a slide member 44 is fixedly attached to the one end 16a by welding etc. The slide member 44 and the support plate portion 22a are fastened together by a fastening device 46, which is comprised of a bolt and a nut, such that the slide member 44 surface-contacts the lower surface of the support plate portion 22a. The sub bracket 16 is thus positioned in the assembled attitude. As shown in FIG. 3 that shows only the slide member 44, the slide member 44 has a slit 48 in its flat plate portion that is supposed to surface-contact the support plate portion 22a, and the fastening device 46 is inserted through the slit 48. The slit 48 is formed substantially parallel to the sub bracket 16 having a longitudinal shape, and is open toward the front of the vehicle. As shown in FIG. 4B, if, in case of a vehicle collision, the dash panel 12 is moved rearward and displaced substantially horizontally toward the rear of the vehicle and the sub bracket 16 is displaced relative to the support member 22, which is displaced by an amount smaller than that of the dash panel 12, toward the rear of the vehicle, the slide member 44 slides toward the rear of the vehicle against the fastening force of the fastening device 46 so that the slit 48 is disengaged from the fastening device 46 toward the rear of the vehicle. A coupled state of the support member 22 and the one end 16a attained by the fastening device 46 is thus cancelled, and the sub bracket 16 together with the slide member 44 is disengaged from the support member 22. The fastening force of the fastening device 46 is determined so that, when the sub bracket 16 is subjected to a predetermined disengagement load that is applied substantially horizontally toward the rear of the vehicle, the slide member 44 is allowed to move toward the rear of the vehicle and be disengaged from the support member 22 and so that, when a load other than the disengagement load is applied, the coupled state is appropriately maintained, namely the sub bracket 16 is appropriately kept supported at its one end 16a, and the sub bracket 16 is held in the assembled attitude. The operation pedal 30 that is depressed can thus be appropriately supported by the sub bracket 16. Alternate long and short dash lines in FIG. 4B show the positions of the sub bracket 16 and the operation pedal 30 in the case where the sub bracket 16 and the operation pedal 30 together with the pedal bracket 14 have been translated together toward the rear of the vehicle with the rearward movement and displacement of the dash panel 12.

If the slide member 44 is further moved toward the rear of the vehicle after disengaged from the support member 22, the slide member 44 contacts a tilted surface 52 of a guide 50. The guide 50 together with the support member 22 is fixed to the instrument panel reinforcement 20, and the tilted surface 52 is a flat surface tilted downward as it gets closer to the rear of the vehicle. Accordingly, if the sub bracket 16 is further moved toward the rear of the vehicle with the rearward movement and displacement of the dash panel 12 even after the slide member 44 contacts the tilted surface 52, the slide member 44 is forced to be displaced toward the lower side of the vehicle along the tilted surface 52, and the sub bracket 16 is withdrawn and rotated clockwise about the second axis S2 as shown by arrow A in FIG. 4B. If the first support shaft 32 is displaced toward the lower side of the vehicle with this withdrawal and rotation of the sub bracket 16, the operation pedal 30 coupled to the intermediate lever 36 via the coupling link 38 is pulled relatively upward by the intermediate lever 36 and is rotated clockwise about the first axis S1 as shown by arrow B. The pedal portion 34 of the operation pedal 30 is thus moved toward the front of the vehicle, and rearward movement of the operation pedal 30 toward the driver's seat is restrained accordingly. At this time, the pedal portion 34 need only be located at least closer to the front of the vehicle than the position shown by the alternate long and short dash line, that is, at least closer to the front of the vehicle than the position of the pedal portion 34 moved rearward with the dash panel 12. For example, the pedal portion 34 may merely rotate with the sub bracket 16 about the second axis S2.

The sub bracket 16 is positioned in the assembled attitude by the temporary fixing pin 24. However, when the one end 16a of the sub bracket 16 is displaced toward the lower side of the vehicle by the guide 50, the temporary fixing pin 24 is broken to allow the sub bracket 16 to be withdrawn and rotated. The temporary fixing pin 24 serves to prevent the sub bracket 16 from swinging before the sub bracket 16 is coupled at its one end 16a to the support member 22, and the temporary fixing pin 24 may be omitted. The temporary fixing pin 24 may be removed after the sub bracket 16 is coupled at its one end 16a to the support member 22.

In such a brake pedal device 10 of the present embodiment, the sub bracket 16, which is coupled to the pedal bracket 14 such that the sub bracket 16 can rotate about the second axis S2, is supported at its one end 16a by the support member 22 mounted on the instrument panel reinforcement 20 such that the one end 16a of the sub bracket 16 can be disengaged from the support member 22. This improves design flexibility of a support structure comprised of the support member 22, and in the present embodiment, the sub bracket 16 is attached at its one end 16a to the support member 22 by the fastening device 46 and the slit 48 such that the one end 16a of the sub bracket 16 can be disengaged from the support member 22. This allows the sub bracket 16 to be held between the support member 22 and the pedal bracket 14 during normal operation so as to appropriately achieve support performance for the operation pedal 30, and allows the one end 16a of the sub bracket 16 to be appropriately disengaged from the support member 22 when the dash panel 12 is moved rearward and displaced in case of a vehicle collision. Even if the pedal bracket 14 is deformed by the collision, the one end 16a of the sub bracket 16 can be reliably disengaged from the support member 22 without being affected by the deformation. Moreover, since the sub bracket 16 is rotated about the second axis S2, this configuration appropriately restrains rearward movement of the pedal portion 34 of the operation pedal 30.

The one end 16a of the sub bracket 16 disengaged from the support member 22 is forced to be displaced toward the lower side of the vehicle by the guide 50 mounted on the instrument panel reinforcement 20. The sub bracket 16 is thus reliably mechanically withdrawn and rotated when the dash panel 12 is moved rearward and displaced. This configuration thus appropriately restrains rearward movement of the pedal portion 34 of the operation pedal 30.

The operation pedal 30 is rotatably disposed in the sub bracket 16 and is coupled to the operating rod 40 via the intermediate lever 36 disposed in the pedal bracket 14. Accordingly, when the sub bracket 16 is withdrawn and rotated toward the lower side of the vehicle as shown by arrow A, the operation pedal 30 is pulled by the intermediate lever 36 and is rotated toward the front of the vehicle as shown by arrow B. This configuration thus appropriately restrains rearward movement of the pedal portion 34 of the operation pedal 30.

The third axis S3 that is the rotation axis of the intermediate lever 36 coincides with the second axis S2, and the intermediate lever 36 and the sub bracket 16 are rotatably supported by the common second support shaft 18. This reduces the number of parts and cost.

The operation pedal 30 is disposed in the sub bracket 16, and only the intermediate lever 36 is disposed in the pedal bracket 14. This configuration can reduce the size and weight of the pedal bracket 14. In particular, this configuration is advantageous in terms of strength because of the short distance (moment) from the second support shaft 18 that receives the loads of the sub bracket 16 and the intermediate lever 36 to the dash panel 12. Accordingly, the weight of the pedal bracket 14 can further be reduced.

The operation pedal 30 is disposed in a part of the sub bracket 16 such that the first axis S1, which is the rotation axis of the operation pedal 30, does not overlap the pedal bracket 14. Accordingly, even if the pedal bracket 14 is deformed by a vehicle collision, the first support shaft 32 is restrained from interfering with the pedal bracket 14, and the sub bracket 16 is withdrawn and rotated appropriately.

Other embodiments of the present invention will be described below. In the following embodiments, substantially the same portions as those of the above embodiment are denoted with the same reference characters and detailed description thereof will be omitted.

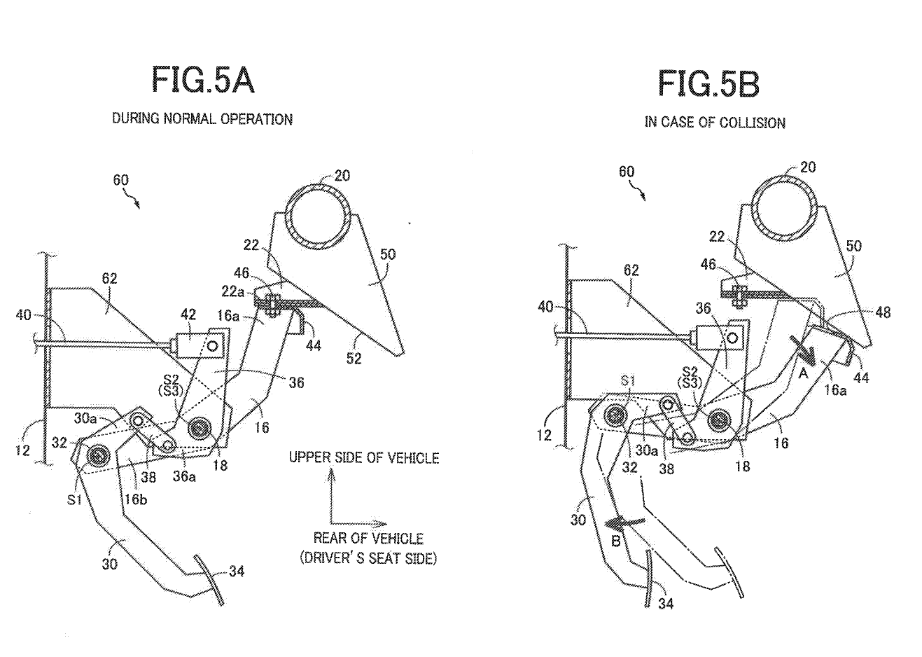

FIGS. 5A and 5B correspond to FIGS. 4A and 4B. In a brake pedal device 60, a pedal bracket 62 is larger than the pedal bracket 14 and is extended toward the rear of a vehicle, and the sub bracket 16 and the intermediate lever 36 are rotatably disposed in a tip end portion of the pedal bracket 62 via the second support shaft 18. The other end 16b of the sub bracket 16 projects toward the front of the vehicle with respect to the second support shaft 18, and the operation pedal 30 is disposed in a part of the other end 16b which does not overlap the pedal bracket 62 as viewed in the side views of FIGS. 5A and 5B such that the operation pedal 30 can rotate about the first axis S1 via the first support shaft 32. An upper end 30a of the operation pedal 30 projects obliquely upward toward the rear of the vehicle with respect to the first support shaft 32, and a lower end 36a of the intermediate lever 36 projects toward the front of the vehicle. The upper end 30a and the lower end 36a are coupled by the coupling link 38.

In such a brake pedal device 60 as well, if, in case of a vehicle collision, the dash panel 12 is moved rearward and displaced toward the rear of the vehicle and the sub bracket 16 is displaced relative to the support member 22 toward the rear of the vehicle as shown in FIG. 5B, the slide member 44 slides toward the rear of the vehicle and is disengaged from the support member 22, and the sub bracket 16 is withdrawn and rotated toward the lower side of the vehicle by the guide 50 as shown by arrow A. If the first support shaft 32 is displaced toward the upper side of the vehicle with this withdrawal and rotation of the sub bracket 16, the upper end 30a of the operation pedal 30 is pulled relatively downward by the intermediate lever 36, whereby the operation pedal 30 is rotated toward the front of the vehicle (clockwise about the first axis S1) as shown by arrow B. This configuration thus has functions and effects similar to those of the above embodiment, such as appropriately restraining rearward movement of the pedal portion 34. Alternate long and short dash lines in FIG. 5B show the positions of the sub bracket 16 and the operation pedal 30 in the case where the sub bracket 16 and the operation pedal 30 have been moved rearward with the dash panel 12, and the pedal portion 34 of the operation pedal 30 need only be moved to a position at least closer to the front of the vehicle than the position shown by the alternate long and short dash line.

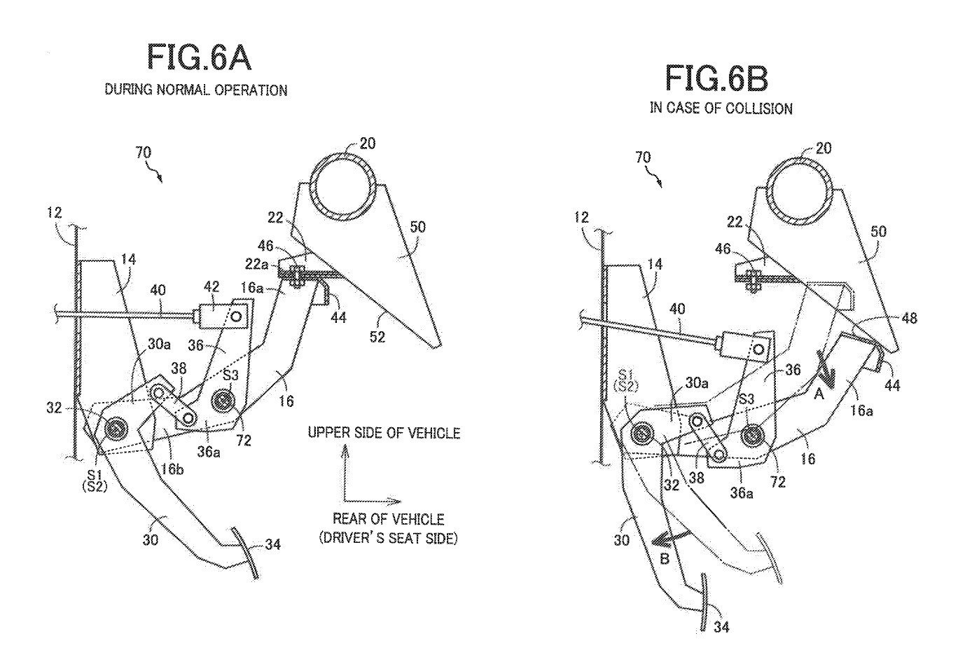

FIGS. 6A and 6B correspond to FIGS. 4A and 4B. A brake pedal device 70 is different from the brake pedal device 60 of FIGS. 5A and 5B in that the brake pedal device 70 uses a smaller pedal bracket 14 than that of the brake pedal device 60 of FIGS. 5A and 5B, and in that the operation pedal 30 is disposed in the pedal bracket 14 such that the operation pedal 30 can rotate about the first axis S1 via the first support shaft 32, and the other end 16b of the sub bracket 16 is mounted on the pedal bracket 14 such that the sub bracket 16 can rotate with the operation pedal 30 about the second axis S2 (that coincides with the first axis S1) via the first support shaft 32. The intermediate lever 36 is disposed in a part of the sub bracket 16 which is located at an intermediate position of the sub bracket 16, that is, at a position between the second axis S2 and the one end 16a, and which does not overlap the pedal bracket 14 as viewed in the side views of FIGS. 6A and 6B. The intermediate lever 36 is disposed such that the intermediate lever 36 can rotate about the axis of a third support shaft 72 substantially parallel to the first support shaft 32. The axis of the third support shaft 72 is the third axis S3 that is the rotation axis of the intermediate lever 36.

In such a brake pedal device 70 as well, if, in case of a vehicle collision, the dash panel 12 is moved rearward and displaced toward the rear of the vehicle and the sub bracket 16 is displaced relative to the support member 22 toward the rear of the vehicle as shown in FIG. 6B, the slide member 44 slides toward the rear of the vehicle and is disengaged from the support member 22, and the sub bracket 16 is withdrawn and rotated toward the lower side of the vehicle by the guide 50 as shown by arrow A. If the third support shaft 72 is displaced toward the lower side of the vehicle with this withdrawal and rotation of the sub bracket 16, the upper end 30a of the operation pedal 30 is pulled downward by the intermediate lever 36, whereby the operation pedal 30 is rotated toward the front of the vehicle (clockwise about the first axis S1) as shown by arrow B. At this time, the intermediate lever 36 is pulled by the operating rod 40 and rotated counterclockwise about the third axis S3. The operation pedal 30 is therefore rotated by a larger amount toward the front of the vehicle. This configuration thus has functions and effects similar to those of the above embodiment, such as appropriately restraining rearward movement of the pedal portion 34. Alternate long and short dash lines in FIG. 6B show the positions of the sub bracket 16 and the operation pedal 30 in the case where the sub bracket 16 and the operation pedal 30 have been moved rearward with the dash panel 12, and the pedal portion 34 of the operation pedal 30 need only be moved to a position at least closer to the front of the vehicle than the position shown by the alternate long and short dash line.

The intermediate lever 36 together with the third support shaft 72 is displaced toward the lower side of the vehicle with the withdrawal and rotation of the sub bracket 16. This configuration reduces the possibility that the intermediate lever 36 is moved toward the rear of the vehicle and contacts the support member 22, the guide 50, etc. to reduce the effect of restraining rearward movement of the pedal portion 34 due to deformation of the intermediate lever 36 etc. The configuration also reduces the possibility that a steering device is moved rearward due to deformation of the instrument panel reinforcement 20. For example, in the embodiment of FIGS. 4A and 4B, the intermediate lever 36 is moved with the pedal bracket 14 toward the rear of the vehicle. Accordingly, the intermediate lever 36 may contact the support member 22 etc.

The second axis S2 that is the rotation axis of the sub bracket 16 coincides with the first axis S1, and the sub bracket 16 and the operation pedal 30 are rotatably supported by the common first support shaft 32. This reduces the number of parts and cost.

The intermediate lever 36 is disposed in a part of the sub bracket 16 such that the third axis S3, which is the rotation axis of the intermediate lever 36, does not overlap the pedal bracket 14. Accordingly, even if the pedal bracket 14 is deformed by a vehicle collision, the third support shaft 72 is restrained from interfering with the pedal bracket 14, and the sub bracket 16 is withdrawn and rotated appropriately.

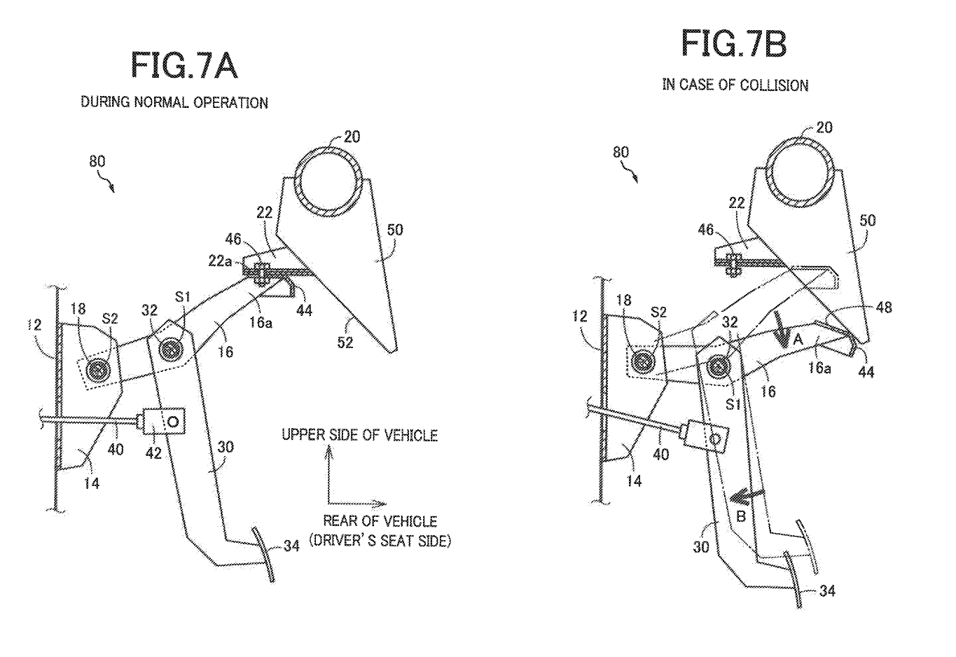

FIGS. 7A and 7B correspond to FIGS. 4A and 4B. A brake pedal device 80 is different from the brake pedal device 10 of FIGS. 4A and 4B in that the operating rod 40 is coupled directly to the operation pedal 30 without using the intermediate lever 36. The operating rod 40 is coupled to the operation pedal 30 at an intermediate position between the first support shaft 32 and the pedal portion 34, namely at a position located below the first support shaft 32. As shown in FIG. 7B, if, in case of a vehicle collision, the dash panel 12 is moved rearward and displaced toward the rear of a vehicle and the sub bracket 16 is displaced relative to the support member 22 toward the rear of the vehicle, the slide member 44 slides toward the rear of the vehicle and is disengaged from the support member 22, and the sub bracket 16 is withdrawn and rotated toward the lower side of the vehicle by the guide 50 as shown by arrow A. If the first support shaft 32 is displaced toward the lower side of the vehicle with this withdrawal and rotation of the sub bracket 16, the operation pedal 30 is pulled at its intermediate position by the operating rod 40, whereby the operation pedal 30 is rotated toward the front of the vehicle (clockwise about the first axis S1) as shown by arrow B. This configuration thus has functions and effects similar to those of the above embodiment, such as appropriately restraining rearward movement of the pedal portion 34. Alternate long and short dash lines in FIG. 7B show the positions of the sub bracket 16 and the operation pedal 30 in the case where the sub bracket 16 and the operation pedal 30 have been moved rearward with the dash panel 12, and the pedal portion 34 of the operation pedal 30 need only be moved to a position at least closer to the front of the vehicle than the position shown by the alternate long and short dash line.

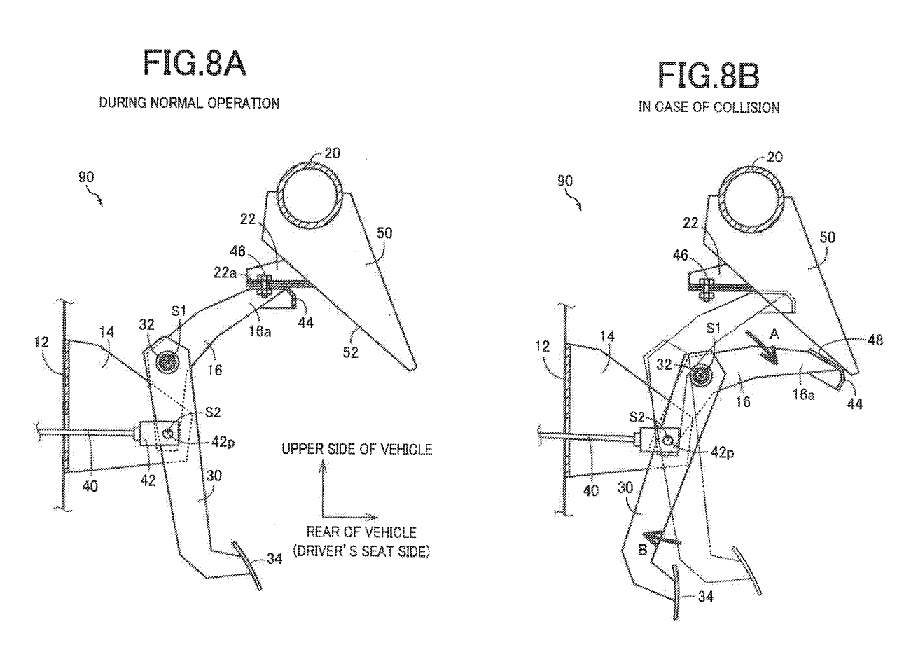

FIGS. 8A and 8B correspond to FIGS. 4A and 4B. A brake pedal device 90 is different from the brake pedal device 80 of FIGS. 7A and 7B in that the sub bracket 16, which is mounted on the pedal bracket 14 such that the sub bracket 16 can rotate about the second axis S2 via the second support shaft 18 (not shown), has a bent shape, namely the sub bracket 16 is extended upward and then bent toward the rear of the vehicle, and in that the operation pedal 30 is disposed in a bent part of the sub bracket 16 at a position above the second axis S2, and in the part of the sub bracket 16 which does not overlap the pedal bracket 14 as viewed in the side views of FIGS. 8A and 8B, such that the operation pedal 30 can rotate about the first axis S1 via the first support shaft 32. A clevis pin 42p of the clevis 42 that couples the operating rod 40 to the operation pedal 30 is coupled to the operation pedal 30 at substantially the same position as that of the second axis S2 as viewed in the side views of FIGS. 8A and 8B. In this case, if the sub bracket 16 is withdrawn and rotated toward the lower side of the vehicle as shown by arrow A in case of a vehicle collision shown in FIG. 8B, the first support shaft 32 is displaced toward the rear of the vehicle with this withdrawal and rotation of the sub bracket 16. At this time, the operation pedal 30 is rotated clockwise about the second axis S2, namely in the direction in which the pedal portion 34 is displaced toward the front of the vehicle, substantially together with the sub bracket 16 as shown by arrow B. This is because the position of the clevis pin 42p coupled to the operating rod 40 is substantially the same as the position of the second axis S2 that is the rotation axis of the sub bracket 16. This configuration thus has functions and effects similar to those of the above embodiment, such as appropriately restraining rearward movement of the pedal portion 34. Alternate long and short dash lines in FIG. 8B show the positions of the sub bracket 16 and the operation pedal 30 in the case where the sub bracket 16 and the operation pedal 30 have been moved rearward with the dash panel 12, and the pedal portion 34 of the operation pedal 30 need only be moved to a position at least closer to the front of the vehicle than the position shown by the alternate long and short dash line.

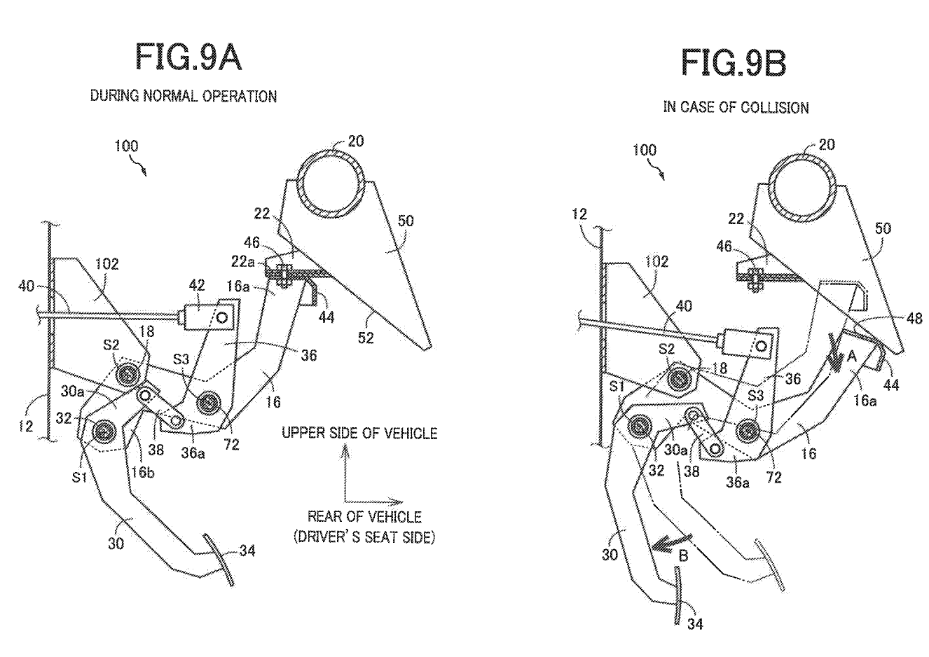

FIGS. 9A and 9B correspond to FIGS. 4A and 4B. A brake pedal device 100 is different from the brake pedal device 70 of FIGS. 6A and 6B in that the brake pedal device 100 uses a pedal bracket 102 that projects toward the rear of a vehicle by an amount slightly larger than that of the pedal bracket 14, and in that the sub bracket 16 is mounted on a tip end portion of the pedal bracket 102 such that the sub bracket 16 can rotate about the second axis S2 via the second support shaft 18. The other end 16b of the sub bracket 16 is extended obliquely downward toward the front of the vehicle with respect to the second support shaft 18, and the operation pedal 30 is disposed in a part of the other end 16b which does not overlap the pedal bracket 102 as viewed in the side views of FIGS. 9A and 9B such that the operation pedal 30 can rotate about the first axis S1 via the first support shaft 32. That is, both the operation pedal 30 and the intermediate lever 36 are disposed in the sub bracket 16, and the first axis S1 and the third axis S3, which are the rotation axes of the operation pedal 30 and the intermediate lever 36, are located on the opposite sides of the second axis S2 in the longitudinal direction of the vehicle.

In such a brake pedal device 100 as well, if, in case of a vehicle collision, the dash panel 12 is moved rearward and displaced toward the rear of the vehicle and the sub bracket 16 is displaced relative to the support member 22 toward the rear of the vehicle as shown in FIG. 9B, the slide member 44 slides toward the rear of the vehicle and is disengaged from the support member 22, and the sub bracket 16 is withdrawn and rotated toward the lower side of the vehicle by the guide 50 as shown by arrow A. If the third support shaft 72 together with the intermediate lever 36 is displaced toward the lower side of the vehicle and the first support shaft 32 together with the operation pedal 30 is displaced toward the upper side of the vehicle with this withdrawal and rotation of the sub bracket 16, the upper end 30a of the operation pedal 30 is pulled downward by the intermediate lever 36, whereby the operation pedal 30 is rotated toward the front of the vehicle (clockwise about the first axis S1) as shown by arrow B. At this time, the intermediate lever 36 is pulled by the operating rod 40 and rotated counterclockwise about the third axis S3. The operation pedal 30 is therefore rotated by a larger amount toward the front of the vehicle. This configuration thus has functions and effects similar to those of the above embodiment, such as appropriately restraining rearward movement of the pedal portion 34. Alternate long and short dash lines in FIG. 9B show the positions of the sub bracket 16 and the operation pedal 30 in the case where the sub bracket 16 and the operation pedal 30 have been moved rearward with the dash panel 12, and the pedal portion 34 of the operation pedal 30 need only be moved to a position at least closer to the front of the vehicle than the position shown by the alternate long and short dash line.

The intermediate lever 36 together with the third support shaft 72 is displaced toward the lower side of the vehicle with the withdrawal and rotation of the sub bracket 16. This configuration reduces the possibility that the intermediate lever 36 is moved toward the rear of the vehicle and contacts the support member 22, the guide 50, etc. to reduce the effect of restraining rearward movement of the pedal portion 34 due to deformation of the intermediate lever 36 etc. The configuration also reduces the possibility that a steering device is moved rearward due to deformation of the instrument panel reinforcement 20.

The operation pedal 30 and the intermediate lever 36 are disposed in parts of the sub bracket 16 such that the first axis S1 and the third axis S3, which are the rotation axes of the operation pedal 30 and the intermediate lever 36, do not overlap the pedal bracket 102. Accordingly, even if the pedal bracket 102 is deformed by a vehicle collision, the first support shaft 32 or the third support shaft 72 is restrained from interfering with the pedal bracket 102, and the sub bracket 16 is withdrawn and rotated appropriately.

Although the embodiments of the present invention are described above in detail based on the drawings, the embodiments are shown by way of example only, and the present invention can be embodied in various modified or improved forms based on the knowledge of those skilled in the art.

### REFERENCE SIGNS LIST

10, 60, 70, 80, 90, 100: Brake pedal device (Vehicle pedal device) 12: Dash panel 14, 62, 102: Pedal bracket 16: Sub bracket 16a: One end 16b: Other end 18: Second support shaft 20: Instrument panel reinforcement (Vehicle body-side member) 22: Support member 30: Operation pedal 32: First support shaft 34: Pedal portion 36: Intermediate lever 38: Coupling link 40: Operating rod (Output member) 50: Guide 72: Third support shaft S1: First axis S2: Second axis S3: Third axis

1. A rearward movement preventing device for a vehicle pedal device, the vehicle pedal device including a pedal bracket that is mounted on a dash panel, and an operation pedal that is directly or indirectly supported by the pedal bracket such that the operation pedal can rotate about a first axis, that is mechanically coupled to a predetermined output member, and that includes at its lower end a pedal portion that is depressed toward a front of a vehicle, and the rearward movement preventing device restraining the pedal portion of the operation pedal from being moved rearward toward a driver's seat when the dash panel is moved rearward and displaced toward the driver's seat, the rearward movement preventing device comprising:
a sub bracket that is coupled to the pedal bracket such that the sub bracket can rotate about a second axis parallel to the first axis, and that has its one end extended beyond the pedal bracket toward a rear of the vehicle; and
a support member that is mounted on a vehicle body-side member located closer to the driver's seat than the dash panel, that supports the one end of the sub bracket, and that allows the one end to be disengaged from the support member when the sub bracket is moved rearward with the rearward movement and displacement of the dash panel,
when the one end is disengaged from the support member, the sub bracket being withdrawn and rotated about the second axis so that the one end is displaced toward a lower side of the vehicle, which allows the pedal portion of the operation pedal to be mechanically restrained from being moved rearward toward the driver's seat based on the mechanical coupling between the output member and the operation pedal.

2. The rearward movement preventing device for the vehicle pedal device according to claim 1, wherein
a guide is mounted on the vehicle body-side member, and the guide guides the one end, having been disengaged from the support member, so that the one end is displaced toward the lower side of the vehicle when the sub bracket is moved rearward with the rearward movement and displacement of the dash panel.

3. The rearward movement preventing device for the vehicle pedal device according to claim 1, wherein
the operation pedal is rotatably disposed in the sub bracket,
an intermediate lever, which is coupled to the output member and is coupled to the operation pedal via a coupling link, is disposed in the pedal bracket such that the intermediate lever can rotate about a third axis parallel to the first axis, and
with the withdrawal and rotation of the sub bracket, the operation pedal is pulled by the intermediate lever and the pedal portion is moved toward the front of the vehicle.

4. The rearward movement preventing device for the vehicle pedal device according to claim 3, wherein
the third axis coincides with the second axis, and the intermediate lever and the sub bracket are rotatably supported by a common support shaft.

5. The rearward movement preventing device for the vehicle pedal device according to claim 1, wherein
the operation pedal is rotatably disposed in the pedal bracket,
an intermediate lever, which is coupled to the output member and is coupled to the operation pedal via a coupling link, is disposed in the sub bracket such that the intermediate lever can rotate about a third axis parallel to the first axis, and
with the withdrawal and rotation of the sub bracket, the operation pedal is pulled by the intermediate lever and the pedal portion is moved toward the front of the vehicle.

6. The rearward movement preventing device for the vehicle pedal device according to claim 5, wherein
the first axis coincides with the second axis, and the operation pedal and the sub bracket are rotatably supported by a common support shaft.

7. The rearward movement preventing device for the vehicle pedal device according to claim 1, wherein
the operation pedal is disposed in the sub bracket at a position located on an upper side of the vehicle with respect to the second axis such that the operation pedal can rotate about the first axis,
the output member is coupled directly to the operation pedal at an intermediate position between the first axis and the pedal portion, and
with the withdrawal and rotation of the sub bracket, the operation pedal is pulled by the output member and the pedal portion is moved toward the front of the vehicle.

8. The rearward movement preventing device for the vehicle pedal device according to claim 1, wherein
the operation pedal is rotatably disposed in the sub bracket, and
an intermediate lever, which is coupled to the output member and is coupled to the operation pedal via a coupling link, is disposed in the sub bracket such that the intermediate lever can rotate about a third axis parallel to the first axis, and
with the withdrawal and rotation of the sub bracket, the operation pedal is pulled by the intermediate lever and the pedal portion is moved toward the front of the vehicle.

9. The rearward movement preventing device for the vehicle pedal device according to claim 8, wherein
the sub bracket has the other end extended toward the front of the vehicle, which is toward an opposite side of the second axis from the one end, and
the operation pedal and the intermediate lever are rotatably disposed in parts of the sub bracket which are located on opposite sides of the second axis in a longitudinal direction of the vehicle.
